(19) United States
(12) Patent Application Publication
(10) Pub. No.: US 2002/0091591 A1
(43) Pub. Date: Jul. 11, 2002

(54) Product information distribution system

(76) Inventors: Kenji Tsumura, Tokyo (JP); Hisayoshi Yanase, Tokyo (JP); Hideo Sakumoto, Tokyo (JP); Masako Okada, Tokyo (JP)

Correspondence Address: Roger T. Frost, KILPATRICK STOCKTON LLP, 2400 Monarch Tower, 3424 Peachtree Road, N.E., Atlanta, GA, 30326, US

(21) Appl. No.: 09/894,507

(22) Filed: Jun. 28, 2001

(30) Foreign Application Priority Data
Jan. 9, 2001 (JP) 2001-1538

(51) Int. Cl. G06F 17/60

(52) U.S. Cl. 705/28

(57) ABSTRACT

The present invention is to provide a product information distribution system that can distribute product information most suitable to the preference of individual customer.

A DB server 21 stores the product guidance information with a product code and the correspondence between the product code and a category code representing classification of preferences in the DB 39 and further stores a weight coefficient corresponding to this category code in the DB 39. The category code of a customer from an agent server 19 is received, and a product code most suitable to the customer's preference is extracted from the DB 39, based on the count of the received category code of the customer and a weight coefficient corresponding to the category code of the customer, and the product contents corresponding to the product code extracted from the DB 39 are read out to prepare distribution information corresponding to the customer.

### BACKGROUND OF THE INVENTION

The present invention relates to a product information distribution system, and more specifically, relates to a product information distribution system that can distribute product information in accord with the needs of individual customers.

Conventionally, as the product information distribution system, there has been known the form of product information, such as door-to-door sales, mail-order sales, direct mail, catalog shopping, TV shopping.

Many of these forms of product information are constructed such that catalogs or the like of the available whole products or new products are presented to all customers, to urge customers to select and order desired products from the presented product catalog.

In addition, with recent development of Internet, virtual shopping malls and auctions on the Internet have been popularized, and some of these send new products information by E-mail to all the registered members.

Moreover, with respect to specific products, product information and catalogs are presented or transmitted only to specific customer groups extracted by specifying necessity minimum retrieval conditions such as age group, gender.

### SUMMARY OF THE INVENTION

With the conventional product information distribution system, however, in the case where retrieval conditions such as age group or gender are specified to perform retrieval, there is a problem in that adequate product information in accord with the needs of individual customers is not always distributed.

In view of the above situation, it is an object of the present invention to provide a product information distribution system which can distribute product information most suitable to the preference of individual customers.

In order to solve the above problem, according to the first aspect of the present invention, there is provided a product information distribution system including a server for exchanging information via an information network with an agent server which collects customer information, wherein the server comprising: product information storing means for storing product guidance information together with a product code added thereto; preference attribute storing means for storing the correspondence between the product code and a preference attribute code representing classification of preferences; weight coefficient storing means for storing a weight coefficient corresponding to the preference attribute code; reception means for receiving a preference attribute code of a customer from the agent server; preference product extraction means for extracting a product code most suitable for the preference of the customer from the preference attribute storing means, based on the count of the received preference attribute code of the customer and the weight coefficient corresponding to the preference attribute code of the customer read from the weight coefficient storing means; distribution information preparation means for preparing distribution information corresponding to the customer by reading out the product contents corresponding to the product code extracted from the product information storing means; and distribution means for distributing the prepared distribution information to the agent server.

According to the second aspect of the present invention, there is provided a product information distribution system comprising a server for connecting communication between a communication terminal of a customer and a virtual mall via an information network, wherein the server comprising: product information storing means for storing product guidance information together with a product code added thereto; preference attribute storing means for storing the correspondence between the product code and a preference attribute code representing classification of preferences; weight coefficient storing means for storing a weight coefficient corresponding to the preference attribute code; product code extraction means for extracting a product code of a product ordered to the virtual mall by the communication terminal of the customer; preference product extraction means for extracting a product code most suitable for the preference of the customer from the preference attribute storing means, based on the count of the preference attribute code corresponding to the extracted product code and the weight coefficient corresponding to the preference attribute code of the customer read from the weight coefficient storing means; distribution information preparation means for preparing distribution information corresponding to the customer by reading out the product contents corresponding to the product code extracted from the product information storing means; and information storing means for storing the prepared distribution information as an E-mail to the customer.

According to the third aspect of the present invention, there is provided a product information distribution system comprising a server for connecting communication between a communication terminal of a customer and the search service side via an information network, wherein the server comprising: product information storing means for storing product guidance information together with a product code added thereto; preference attribute storing means for storing the correspondence between the product code and a preference attribute code representing classification of preferences; URL address storing means for storing a URL address corresponding to the preference attribute code; weight coefficient storing means for storing a weight coefficient corresponding to the preference attribute code; URL address extraction means for extracting the URL address provided to the communication terminal of the customer by the search service side; preference product extraction means for extracting a product code most suitable for the preference of the customer from the preference attribute storing means, based on the count of the preference attribute code corresponding to the extracted URL address and the weight coefficient corresponding to the preference attribute code of the customer read from the weight coefficient storing means; distribution information preparation means for preparing distribution information corresponding to the customer by reading out the product contents corresponding to the product code extracted from the product information storing means; and information storing means for storing the prepared distribution information as an E-mail to the customer.

A product information distribution system according to the fourth aspect of the present invention, wherein the preference product extraction means determines a first product based on the count of the preference attribute code of the customer received by the reception means and the weight coefficient corresponding to the preference attribute code of the customer read from the weight coefficient storing means; determines a third product based on the count of the preference attribute code corresponding to the product code extracted by the product code extraction means and the weight coefficient corresponding to the preference attribute code of the customer read from the weight coefficient storing means; determines a second product based on the count of the preference attribute code corresponding to the URL address extracted by the URL address extraction means and the weight coefficient corresponding to the preference attribute code of the customer read from the weight coefficient storing means; and extracts a product code most suitable for the preference of the customer from the preference attribute storing means, based on a preference attribute code in the case where the sum total of the first product, the second product and the third product is larger than a predetermined reference value.

A product information distribution system according to the fifth aspect of the present invention, wherein the distribution information preparation means prepares advance notice information prior to the designated date designated by the customer by a predetermined period.

A product information distribution system according to the sixth aspect of the present invention, wherein the distribution information preparation means prepares product contents having a product code corresponding to a preference attribute code of which the count corresponding to the product code extracted by the product code extraction means has reached a predetermined reference value as the distribution information when it becomes the specified time.

A product information distribution system according to the seventh aspect of the present invention, wherein the distribution information preparation means prepares product contents having the product code as the distribution information when the count value of the preference attribute code corresponding to a specified product code has reached a predetermined reference value.

According to the eighth aspect of the present invention, there is provided a product information distribution system including a server for communicating with a communication terminal of a non-customer via an information network, wherein the server comprising: product information storing means for storing product guidance information together with a product code added thereto; preference attribute storing means for storing the correspondence between the product code and a preference attribute code representing classification of preferences; URL address storing means for storing a URL address corresponding to the preference attribute code; weight coefficient storing means for storing a weight coefficient corresponding to the preference attribute code; URL address extraction means for extracting the URL address at the time when a communication terminal of the non-customer searched the database provided in the server; preference product extraction means for extracting a product code most suitable for the preference of the non-customer from the preference attribute storing means, based on the count of the preference attribute code corresponding to the extracted URL address and the weight coefficient corresponding to the preference attribute code of the customer read from the weight coefficient storing means; distribution information preparation means for preparing distribution information corresponding to the non-customer by reading out the product contents corresponding to the product code extracted from the product information storing means; and information storing means for storing the prepared distribution information as an E-mail to the non-customer.

### BRIEF DESCRIPTION OF THE DRAWINGS

FIG. 1 is a diagram showing the overall construction of a product information distribution system 11 according to a first embodiment of the present invention;

FIGS. 2A to 2C are diagrams showing the data structure of DB39;

FIG. 3(3A-3C) is a diagram showing the data structure of the DB39;

FIG. 4 is a flowchart for explaining the operation of the product information distribution system 11 according to the first embodiment of the present invention;

FIG. 5 is a sequence diagram for taking in the customer's attribute;

FIG. 6 is a sequence diagram for taking in a search history via the Internet;

FIG. 7 is a sequence diagram for taking in the data of the virtual mall user;

FIG. 8 is a diagram showing the preparation procedure (A) of a preference table and the preference table (B);

FIG. 9 is a flowchart of a preparation subroutine of a sales history table;

FIGS. 10 (A) to 10 (D) are diagrams showing the preparation procedure of the sales history table;

FIG. 11 is a flowchart of a preparation subroutine of a search history table;

FIGS. 12 (A) to 12 (D) are diagrams showing a preparation subroutine of the search history table;

FIG. 13 is a flowchart of a preparation subroutine of a search table;

FIGS. 14 (A) to 14 (E) are diagrams showing a preparation subroutine of the search table;

FIG. 15 is a flowchart of a preparation subroutine of the distribution data;

FIG. 16 is a flowchart of a subroutine of condition judgment processing (1-1);

FIG. 17 is a flowchart of a subroutine of condition judgment processing (2);

FIG. 18 is a flowchart of a subroutine of condition judgment processing (1-2);

FIG. 19 is a flowchart of a subroutine of condition judgment processing (1-3);

FIG. 20 is a display example on an inquiry screen;

FIG. 21 is a flowchart f or explaining the operation of the product information distribution system 11 according to a fourth embodiment of the present invention; and

FIG. 22 is a flowchart of a subroutine of condition judgment processing (1-4).

### DESCRIPTION OF THE PREFERRED EMBODIMENT

<First Embodiment>

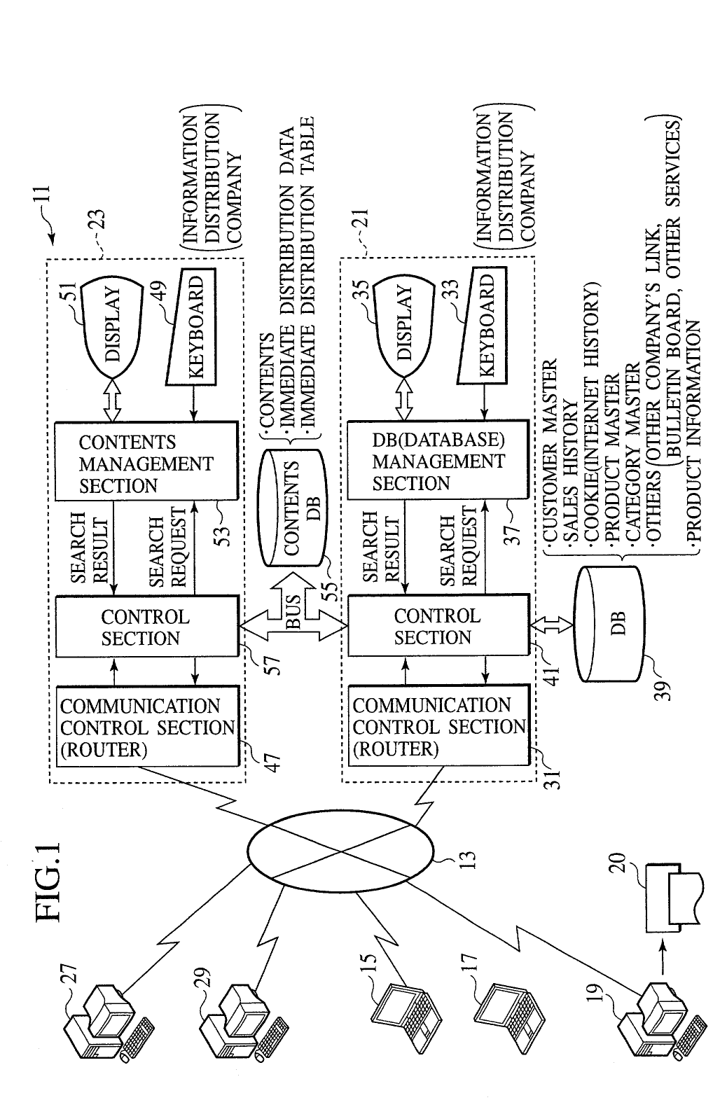

FIG. 1 is a diagram showing the overall construction of a product information distribution system 11 according to the first embodiment of the present invention. As shown in FIG. 1, to the Internet 13 for performing information communication such as home page or E-mail, there are connected communication terminals 15 of customers, an agent server 19 provided in an agent for exchanging data with a mobile terminal 17 carried by a sales person, a DB (database) server 21 and a Web server 23 provided in the information distribution company, a mall server 27 for providing a virtual mall, and a Web server 29 provided in an optional operating company for performing information communication such as home page or E-mail.

The agent server 19 collects customer data from the mobile terminal 17 and transmits the data to the DB server 21 via the Internet 13, as well as receiving immediate distribution data from the DB server 21 to print it out by a printer 20 as an information document.

The DB server 21 comprising: a communication control section 31 having a router for exchanging communication information with the agent server 19 via the Internet; a DB managing section 37 for inputting instruction information from a keyboard 33 and displaying the screen information on a display 35; and a control section 41 for controlling the entire DB server. Furthermore, DB 39, contents DB 55 and a control section 57 of the Web server 23 are connected to the control section 41.

The Web server 23 comprising: a communication control section 47 having a router for exchanging communication information with an optional server and communication terminals via the Internet 13; a contents managing section 53 for inputting instruction information from a keyboard 49 and displaying the screen information on a display 51; and a control section 58 for controlling the entire Web server. Furthermore, the contents DB 55 and the control section 41 of the DB server 21 are connected to the control section 57.

The control section 41, 57 comprise: a RAM (not shown) for storing control data; a ROM (not shown) for storing a control program; a CPU (not shown) for controlling the system according to the control program; and a timer (not shown) for clocking and outputting the current time to the CPU.

Data Structure of the DB 39 Connected to the DB Server 21

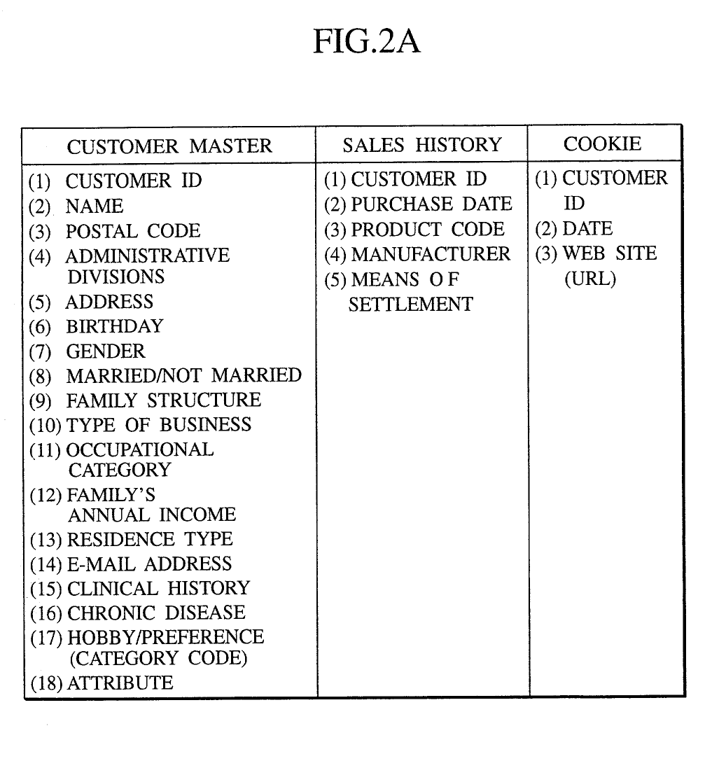

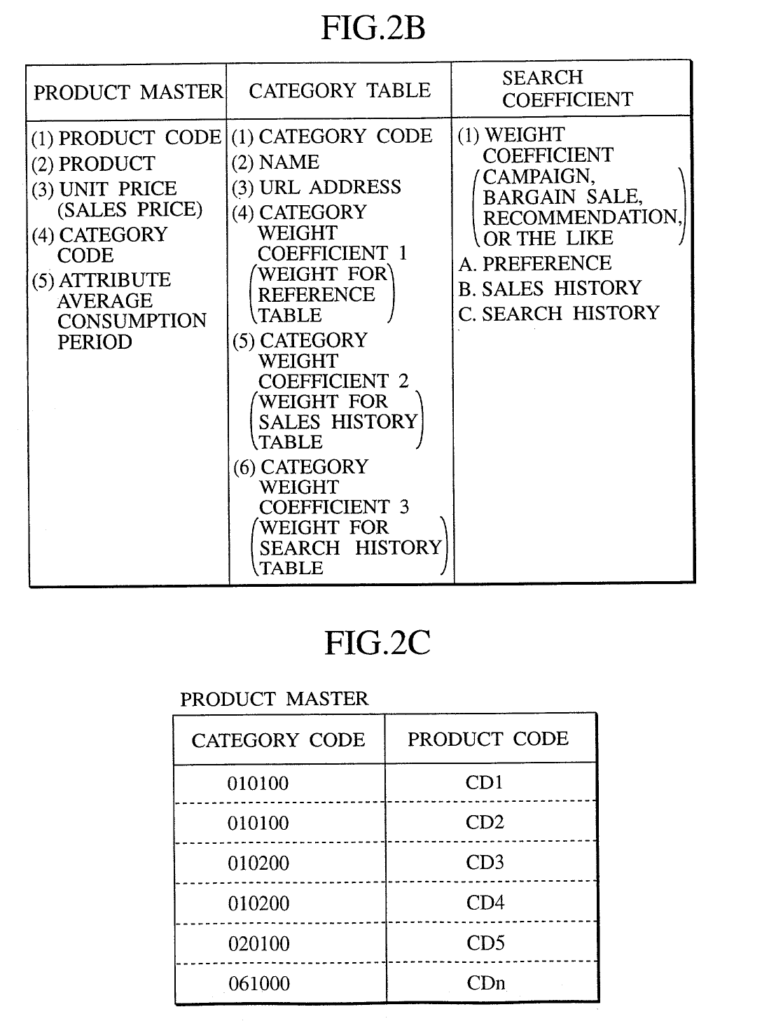

As shown in FIGS. 2A and 2B, the DB 39 stores the customer master, sales history, cookie, product master, category table and search coefficient as the database. Moreover, as described later, the DB 39 stores information regarding other company's links, a bulletin board and other services and product information regarding individual product.

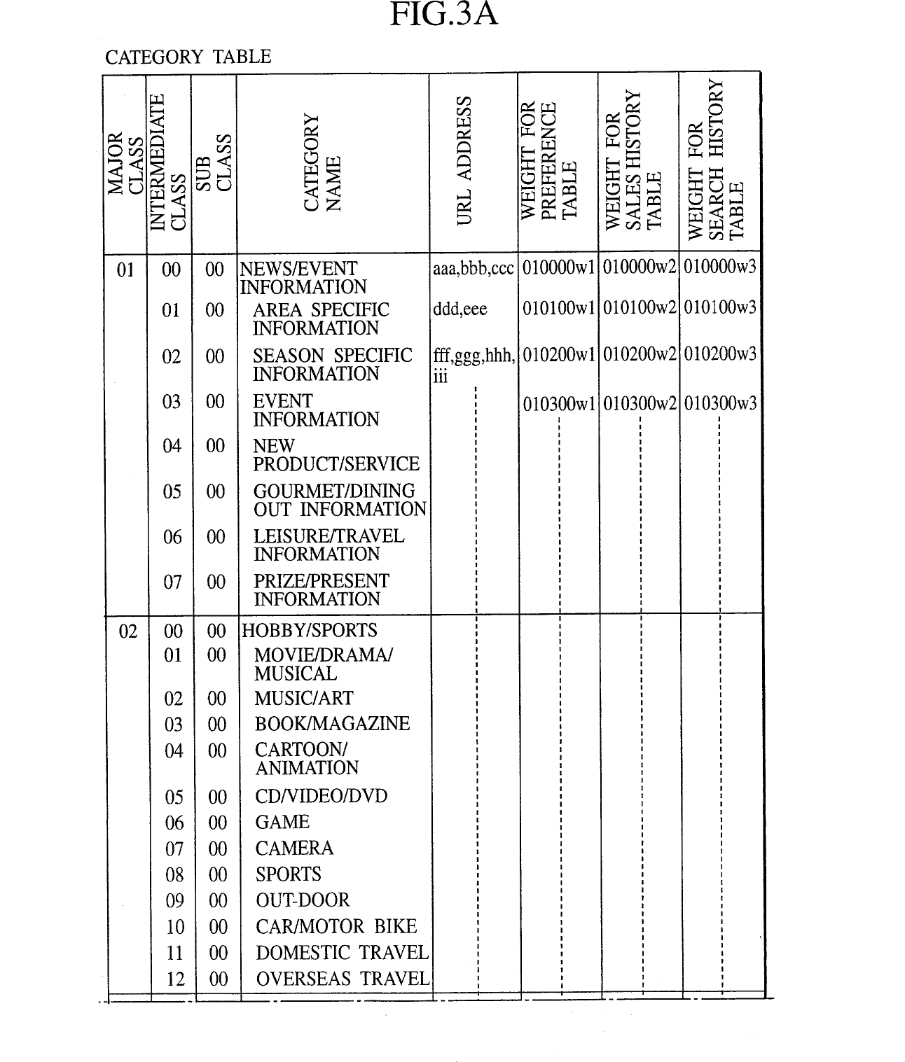

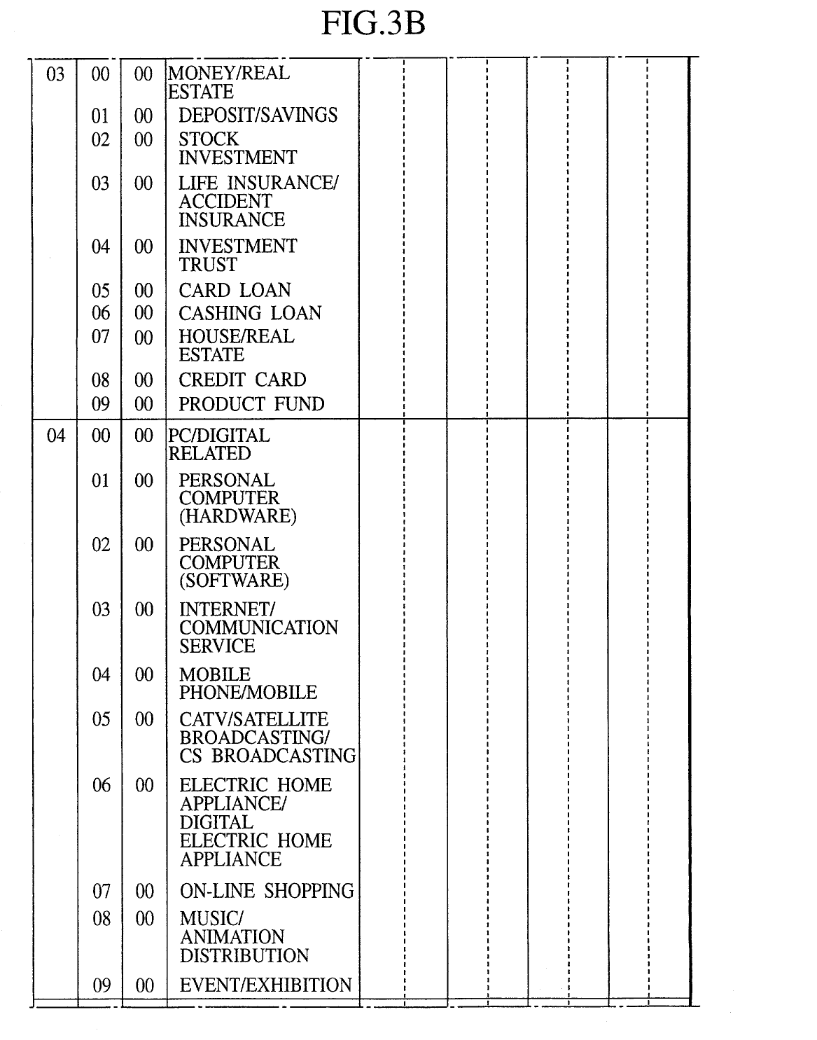

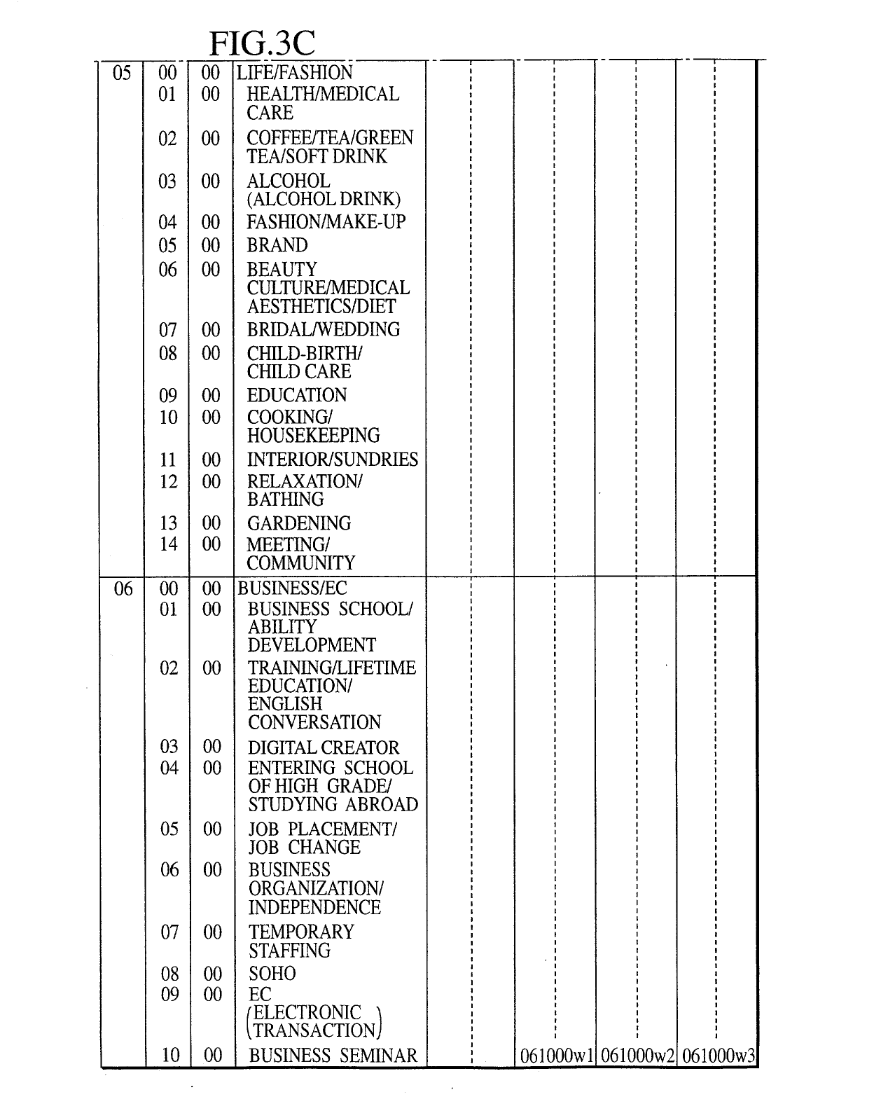

Specifically, the product master stores, as shown in FIG. 2C, the correspondence between category codes representing classification of preferences and product codes. The category table stores, as shown in FIG. 3 (FIG. 3A-FIG. 3C), detailed names of the category names, URL addresses, weight for preference table, weight for sales history table, and weight for search history table, using class, intermediate class and subclass.

The URL addresses stored in the category table are to be handled, for example, such that the portion of “xxx.xxx.xxx.xxx” located between “//” and “/” of an URL address “http:// xxx.xxx.xxx.xxx/ zzz.zzz” is regarded as the URL address.

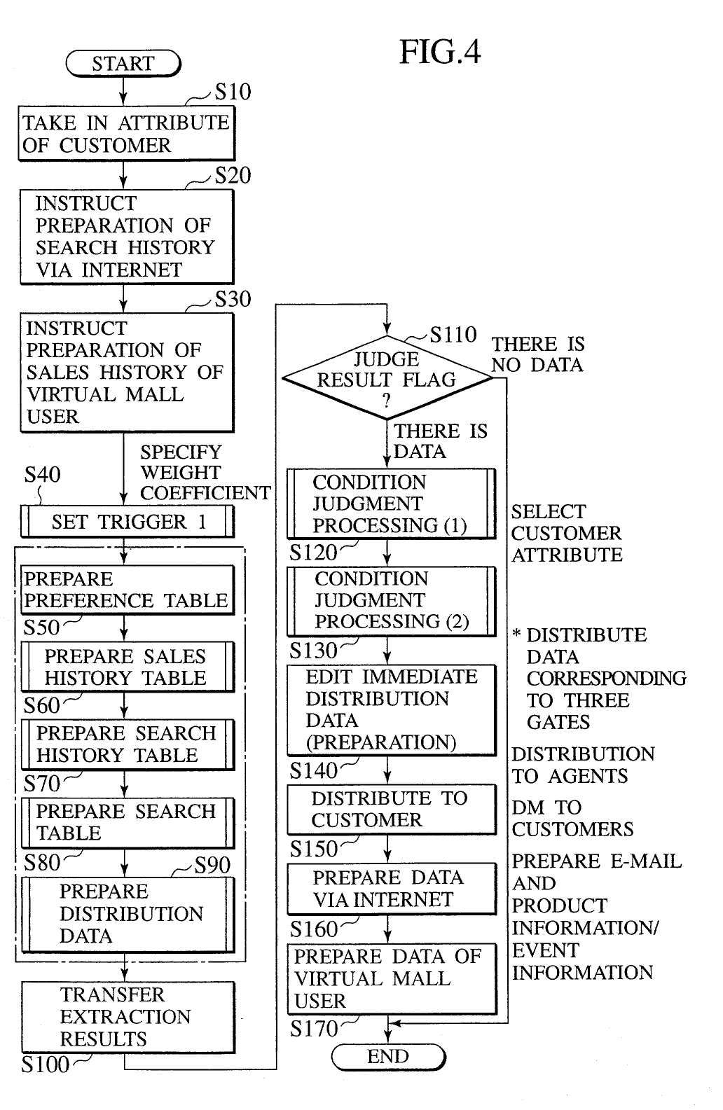

The operation of the product information distribution system 11 will be described with reference to the flowchart shown in FIG. 4.

(1) A Method for Collecting Customer Data Via the Agent Server 19

A sales person directly interviews a new customer and inputs the collected results to a mobile terminal 17, as a preference (taste) attribute of the customer, such as name, postal code, administrative divisions, address, birthday, gender, married/not married, family structure, type of business, family's annual income, residence type, E-mail address, clinical history, chronic disease, hobby/preference (category code), registered attribute, to be stored therein.

The sales person having returned to the agent office updates the attribute data regarding the preference of the customer stored in the mobile terminal 17 and stores the data in the DB (database) (not shown) provided in the agent server 19. The sales person may not return to the agent office, but activate WWW browser stored in the mobile terminal 17 and transmit the collected customer attribute to the agent server 19 via the Internet to be stored in the DB provided in the agent server 19.

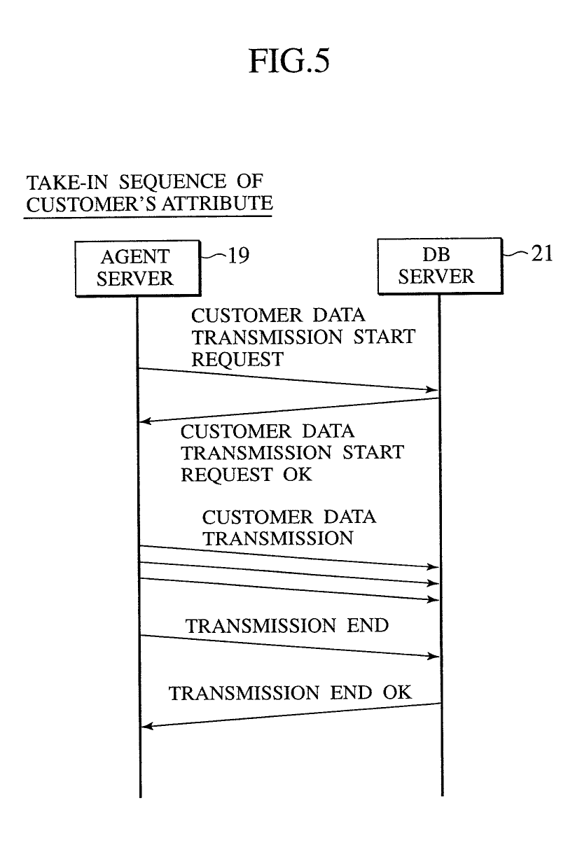

Furthermore, as shown in FIG. 5, the agent server 19 transmits a customer data transmission start request for transmitting the customer data to the DB server 21 via the Internet 13.

In step S10, the DB server 21 takes in the attribute data regarding the preference of the customer collected and stored in the agent server 19 via the Internet 13.

That is to say, the DB server 19 transmits the customer data transmission start request OK information representing the transmission permission to the agent server 19 corresponding to the customer data transmission start request received from the agent server 19.

The agent server 19 having received the customer data transmission start request OK information from the DB server 21 sequentially reads out the updated customer data from the database to transmit the data to the DB server 21, and after the completion of transmission of the customer data, the agent server 19 transmits transmission END to the DB server 21.

On the other hand, the DB server 21 having received the customer data and transmission END from the agent server 19 stores the customer data in the DB 39, and transmits transmission END OK information representing confirmation of transmission END, corresponding to the transmission END to the agent server 19.

The DB server 21 having received the customer attribute data from the agent server 19 generates a customer master by adding a characteristic customer ID to the customer attribute data, and stores it in the DB 39.

As a result, as shown in FIG. 2A, the customer master comprising customer ID, name, postal code, administrative divisions, address, birthday, gender, married/not married, family structure, type of business, family's annual income, residence type, E-mail address, clinical history, chronic disease, hobby/preference (category code), registered attribute or the like are stored in the DB 39.

(2) A Method for Collecting Search History at the Time of Using the Internet

When a customer makes an Internet connection agreement with a provider (information distribution company), each customer is to be provided with a characteristic customer ID and an E-mail address.

According to the product information distribution system of the present invention, when a communication terminal 15 of the customer utilizes the search service via the Internet 13, after the search, it is possible to collect the search history representing which URL address was specified for communication.

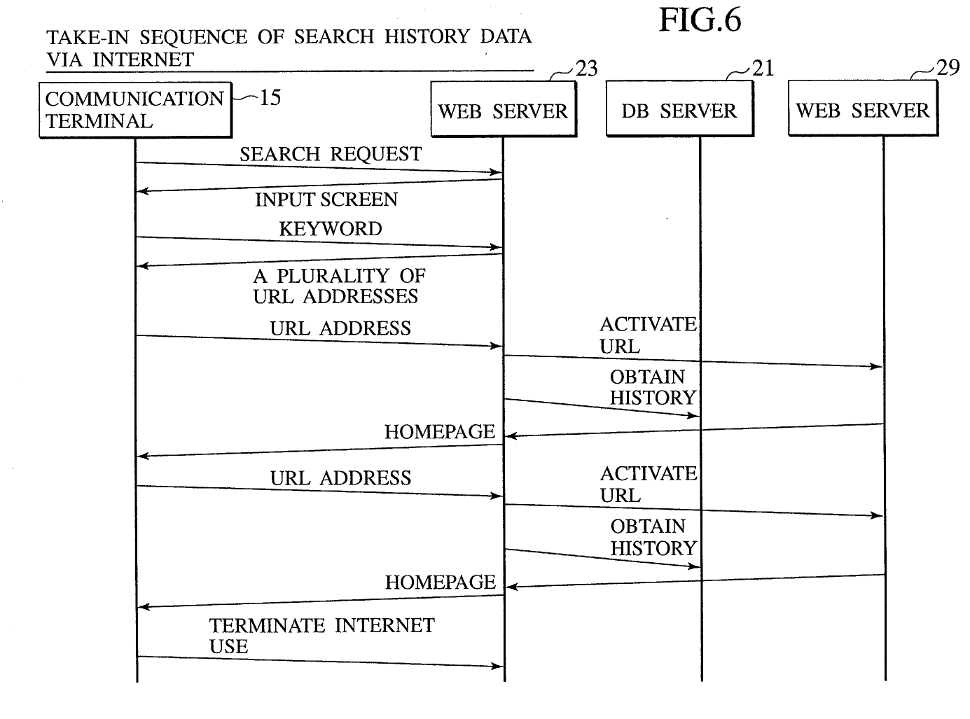

That is to say, as shown in FIG. 6, for example, a communication terminal 15 such as a personal computer provided in the customer's residence is powered on to activate the WWW browser. When a search button displayed on the display screen is clicked, the telephone line is connected to the telephone number of a provider (information distribution company) having a connection agreement with the customer. Then, the customer ID is verified between the customer's communication terminal 15 and the communication control section 47 of the Web server 23, and the customer ID is transmitted to the operating company which provides the search service via the communication control section 47 of the Web server 23. From this server, the input screen for the search keyword is transmitted back to the communication terminal 15, and downloaded to the communication terminal 15.

When a keyword for search is input and specified in the input area on this input screen, and for example, the search button is pushed, the keyword is transmitted to the search service side. On the search service side, a plurality of URL addresses containing the specified keyword are searched from the contents database registered and made public, and transmitted back to the communication terminal 15.

As a result, a plurality of URL addresses is displayed on the display screen of the communication terminal 15, and when one URL address is selected among these and clicked, the URL address is connected to an optional Web server 29 specified by the URL address via the Internet 13 and the communication control section 47 of the Web server 23.

Then, the data of the homepage specified by the URL address is transmitted to the communication terminal 15 via an optional Web server 29, the Internet 13, the communication control section 47 of the Web server 23, and the Internet 13. As a result, with the communication terminal 15, this homepage can be accessed.

At this time, in step S20, the DB server 21 generates a search history preparation instruction for storing in the DB server 21 the search history (cookie) representing the search result in the above-described search service from the Internet 13 via the Web server 23, and outputs this to the Web server 23 via a bus. Then, the Web server 23 having received the search history preparation instruction from the DB server 21 instructs the communication control section 47 to obtain search history (cookie) including the customer ID, date, and the URL address of the Web site from the communication information accessing now to the communication control section 47, and stores this search history, as shown in FIG. 2A, in the DB 39 managed by the DB server 21, from the Web server 23 via a bus.

(3) A Method for Collecting Sales History at the Time of Using a Virtual Mall

According to the product information distribution system of the present invention, it is possible to collect communication history representing which URL address was specified for communication when a communication terminal 15 of a customer utilizes a virtual mall via the Internet 13.

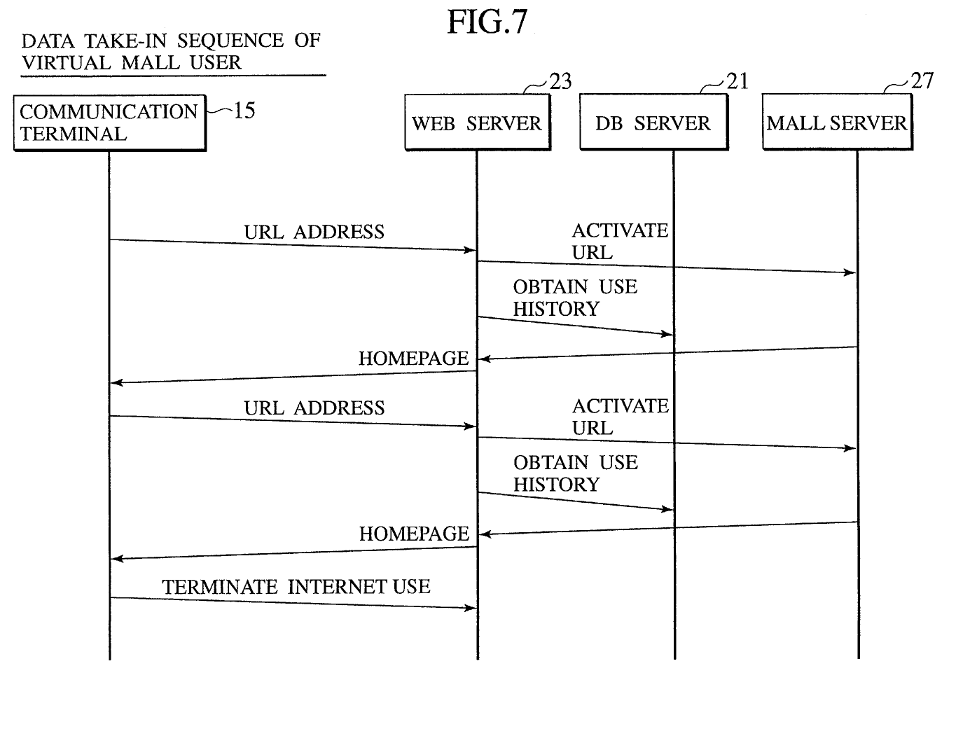

That is to say, as shown in FIG. 7, for example, the communication terminal 15 such as a personal computer provided in the customer's residence is powered on to activate the WWW browser. When a specific URL address is input to start transmission to the Internet 13, the telephone line is first connected to the telephone number of a provider (information distribution company) having a connection agreement with the customer. Then, the customer ID is verified between the customer's communication terminal 15 and the communication control section 47 of the Web server 23. The communication terminal is then connected to an optional mall server 27 specified by the URL address via the communication control section 47 of the Web server 23.

Then, the mall server 27 connected to the communication terminal 15 via the communication control section 47 of the Web server 23 and the Internet 13 transmits the data of homepage in the shopping mall specified by the URL address to the communication terminal 15 via the communication control section 47 of the Web server 23. As a result, with the communication terminal 15, the homepage of this shopping mall can be accessed and application of purchase of a product can be done through the Internet 13.

At this time, in step S30, the DB server 21 generates a sales history preparation instruction for storing in the DB server 21 sales history described above from the Internet 13 via the Web server 23, and outputs this to the Web server 23 via a bus. Then, the Web server 23 having received the sales history preparation instruction from the DB server 21 instructs the communication control section 47 to obtain the sales history including the customer ID, purchase date, product code, manufacturer, and means of settlement from the communication information accessing now to the communication control section 47, and stores this sales history, as shown in FIG. 2A, in the DB 39 managed by the DB server 21, from the Web server 23 via a bus.

In the contents DB 55 of the Web server 23, there is stored a questionnaire form for registering the customer's attribute data in the same format as that of the customer master shown in FIG. 2A, and by moving from the menu page to the questionnaire page of the Web server 23, this questionnaire form can be downloaded to the communication terminal 15 of the customer. When the customer enters the own attribute data in the questionnaire form and then pushes the transmission button added in this page, the response to the questionnaire is transmitted to the Web server 23 and uploaded. Furthermore, this response is transferred to the DB server 21 from the Web server 23 via a bus. Then, the DB server 21 having received the customer's attribute data from the Web server 23, adds a characteristic customer ID to the customer's attribute data to generate a customer master, and stores this in the DB 39.

Next, in step S40, a weight coefficient for each search such as the preference table, the sales history table and the search history table is set as trigger 1 from the keyboard 33 according to the instruction on the set screen displayed on the display 35 in the DB server 21, to thereby prepare reference data in the equation (1) described later.

(4) A Method For Preparing Each Search Table

At first, in step S50, a preference table is prepared, at the time of updating the customer master stored in the DB 39 in the DB server 21. Moreover, the preference table may be prepared from the response results of the questionnaire from the customer.

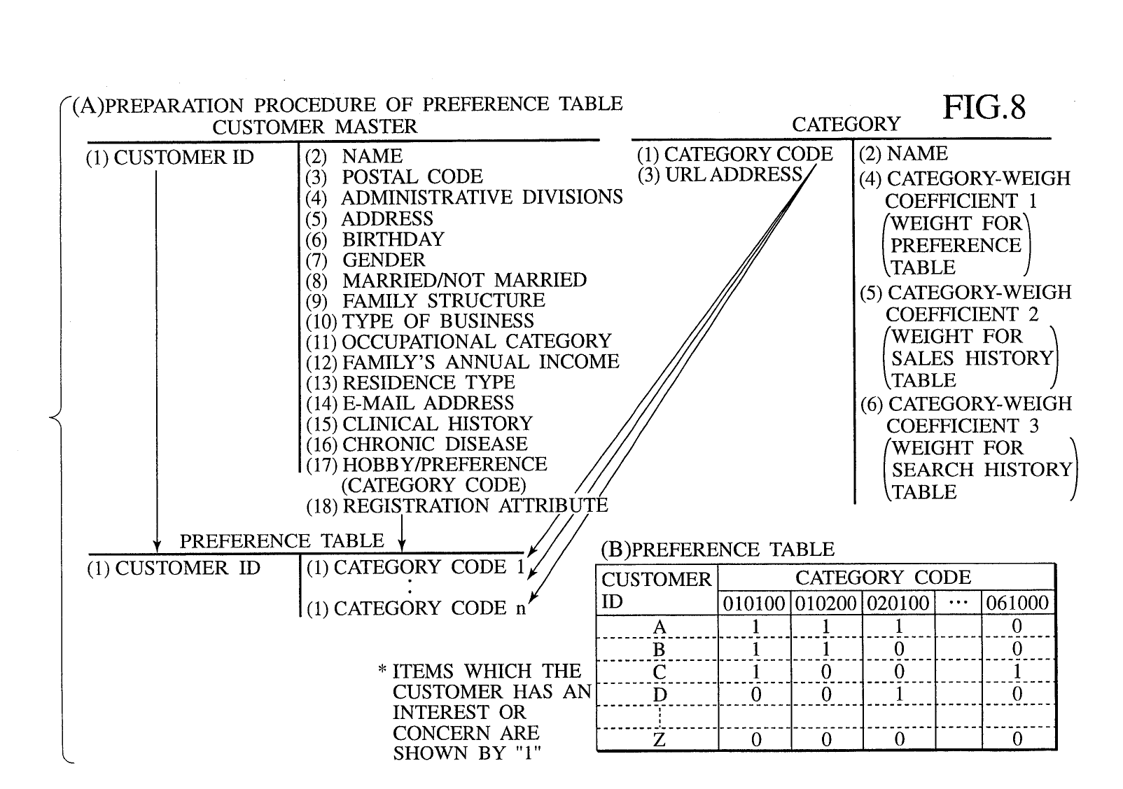

That is to say, as in the preparation procedure of the preference table shown in FIG. 8 (A), respective customer IDs are read from all the customer masters stored in the DB 39 at first, and allotted as the customer ID in the longitudinal direction of the preference table as shown in FIG. 8 (B). Next, respective category codes are read out from the product master stored in the DB 39, and allotted as the category code in the lateral direction of the preference table as shown in FIG. 8 (B).

Furthermore, with respect to each customer ID, “1” is set to an item to which the customer has an interest or concern and “0” is set to an item to which the customer does not have an interest or concern in the preference table for each category code, referring to the hobby/preference (category code), of the customer masters stored in the DB 39. As a result, a preference table as shown in FIG. 8 (B) can be prepared.

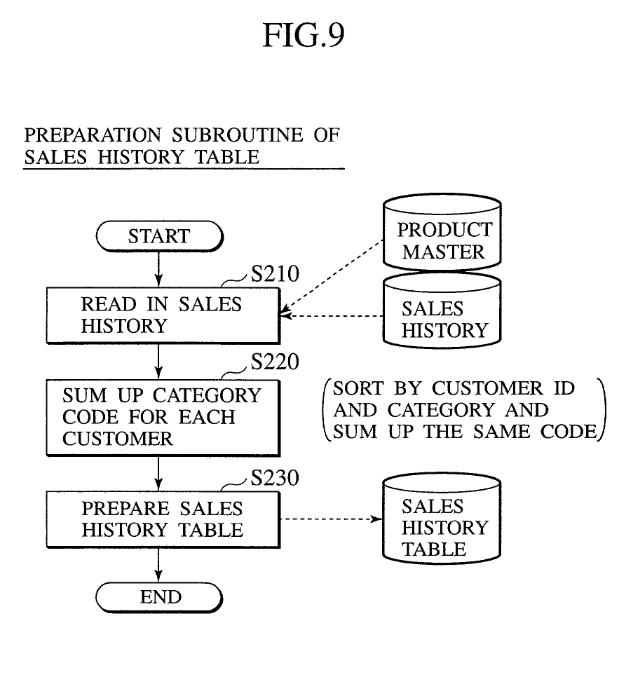

Next, in step S60, a subroutine (FIG. 9) for preparing the sales history table is called up from the sales history.

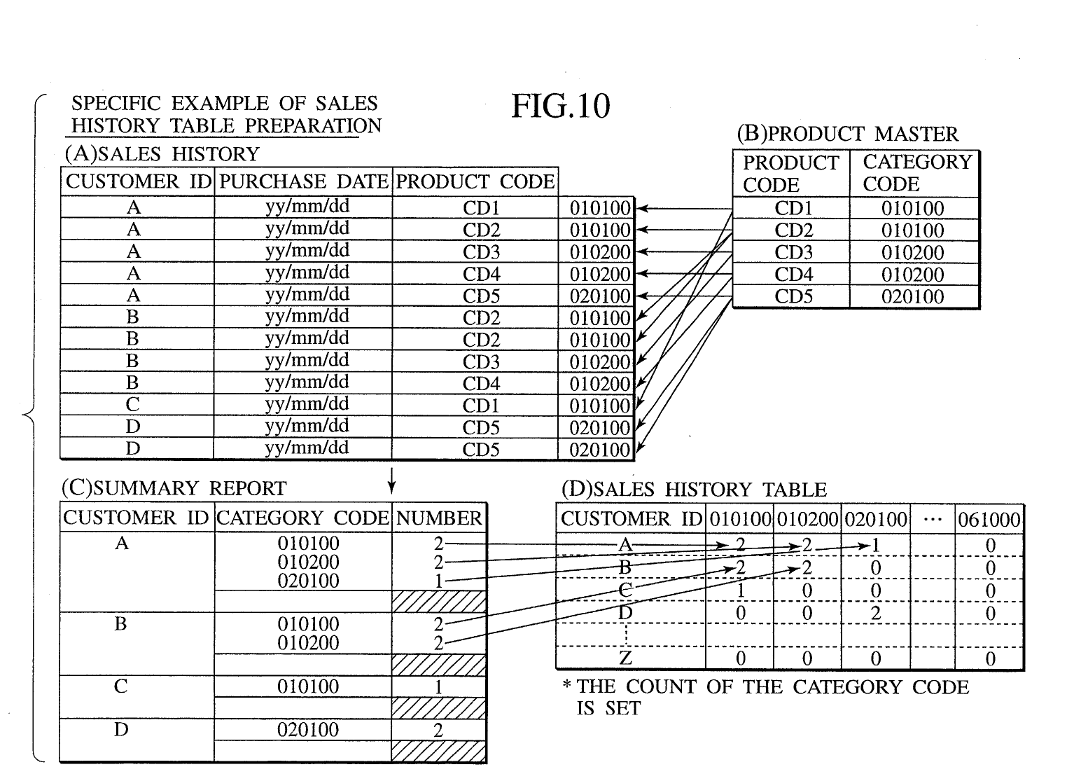

As shown in FIG. 9, in step S210, the control section 41 of the DB server 21 reads in the purchase date and the product code regarding each customer ID to the RAM from the sales history stored in the DB 39, and as shown in FIG. 10 (A), obtains a category code corresponding to the product code read in to the RAM, referring to the product master (FIG. 10 (B)).

In step S220, the category codes are added up for each customer ID. That is to say, as in the summary report shown in FIG. 10 (C), the count of the same category code is calculated for each customer ID.

In step S230, the sales history table is prepared. That is to say, as shown in FIG. 10 (D), the customer ID is allotted in the longitudinal direction of the sales history table. Next, respective category codes are read out from the product master stored in the DB 39, and allotted as the category code in the lateral direction of the preference table, as shown in FIG. 10 (D). Furthermore, the count of the category code calculated in step S220 is respectively set for each customer ID.

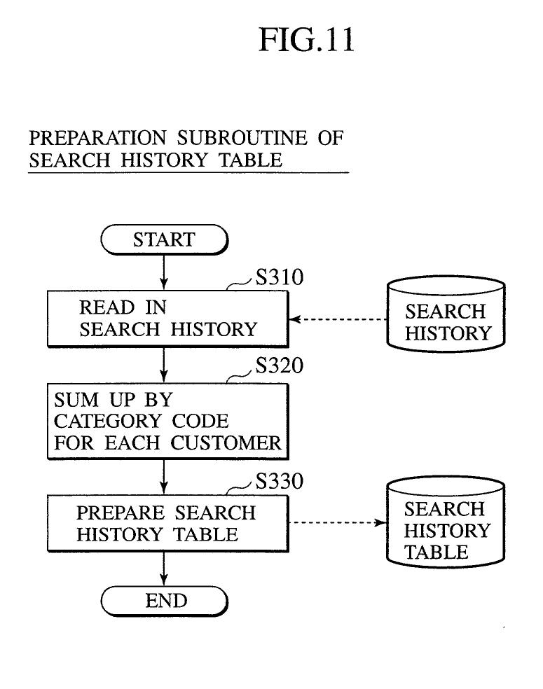

Next, in step S70, a subroutine (FIG. 11) is called up for preparing the search history table from the search history.

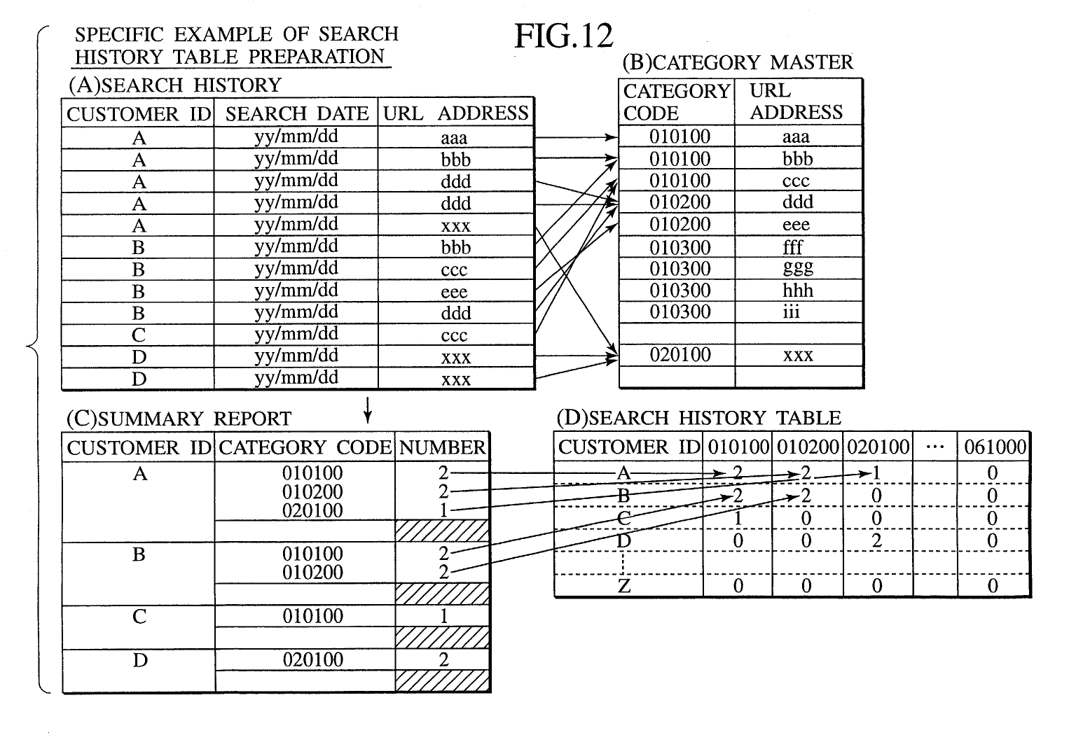

As shown in FIG. 11, in step S310, the control section 41 of the DB server 21 reads in the search date and the URL address regarding each customer ID to the RAM from the search history stored in the DB 39 as shown in FIG. 12(A).

In step S320, the control section 41 of the DB server 21 obtains a category code corresponding to the URL address read in to the RAM, referring to the category master (FIG. 12 (B)). Furthermore, the category codes are added up for each customer ID. That is to say, as in the summary report shown in FIG. 12 (C), the count of the same category code is calculated for each customer ID.

In step S330, the search history table is prepared. That is to say, as shown in FIG. 12 (D), the customer ID is allotted in the longitudinal direction of the search history table. Next, respective category codes are read out from the product master stored in the DB 39, and allotted as the category code in the lateral direction of the search table, as shown in FIG. 12 (D). Furthermore, the count of the category code calculated in step S320 is respectively set for each customer ID.

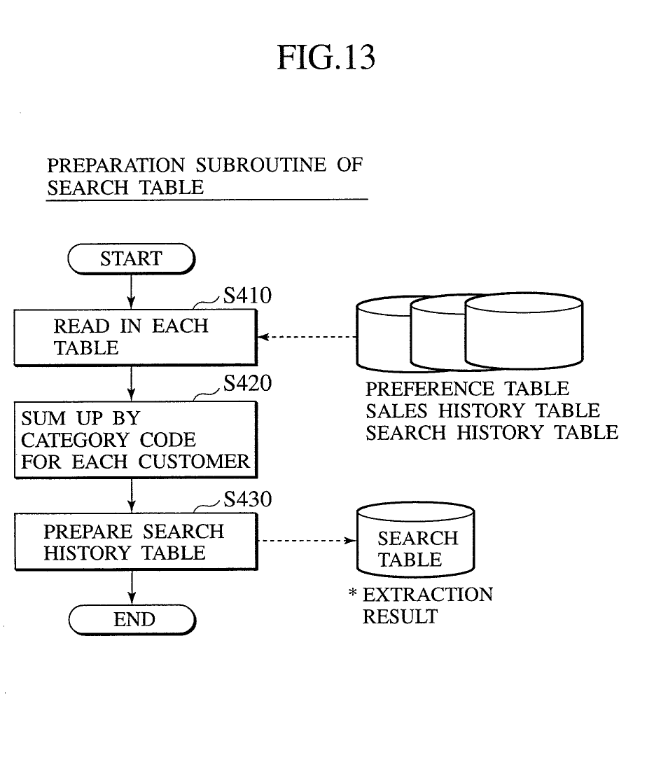

Next, in step S80, a subroutine (FIG. 13) is called up for preparing the search table from the preference table, the sales history table and the search history table.

As shown in FIG. 13, in step S410, the control section 41 of the DB server 21 reads in the preference table, the sales history table and the search history table stored in the DB 39 to the RAM.

In step S420, the control section 41 of the DB server 21 sums up the category codes for each customer ID from each table read in to the RAM. That is to say, the count of the same category code is read from each table and counted up for each customer ID.

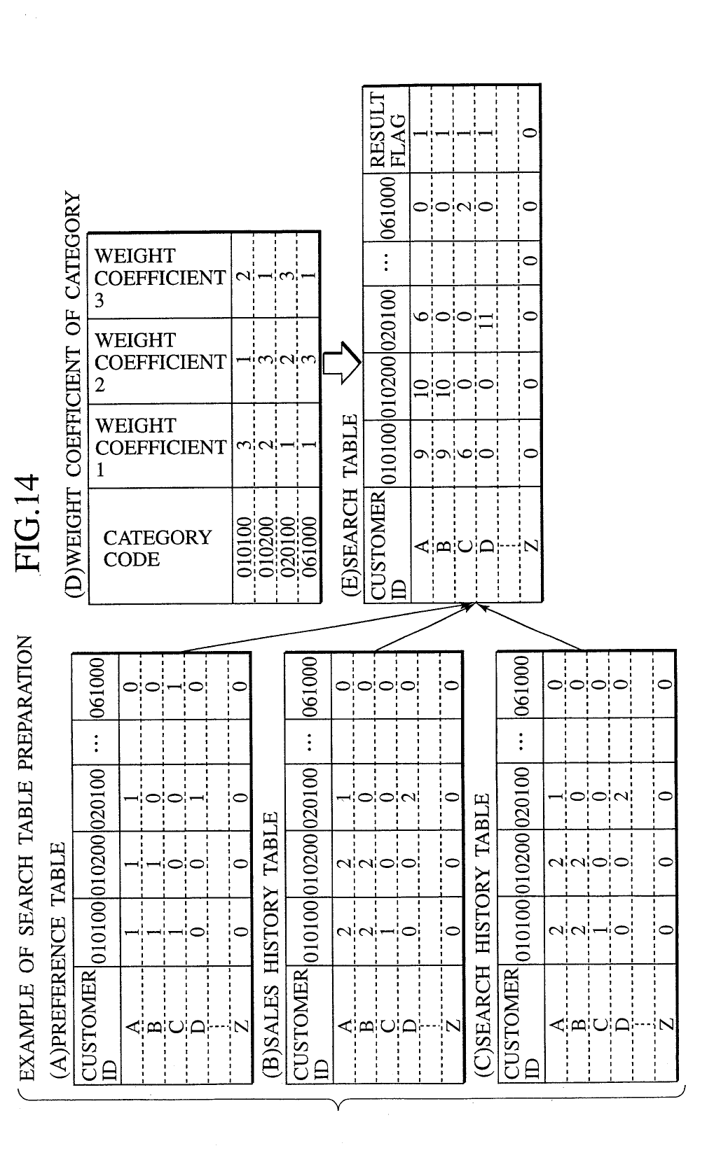

In step S430, a search table is prepared. That is to say, as shown in FIG. 14 (E), the customer ID is allotted in the longitudinal direction of the search table. Next, respective category codes are read out from the product master stored in the DB 39, and allotted in the lateral direction (x) of the search table. Furthermore, calculations are performed according to the equation (1) for each category code of each customer ID, based on the count value Stx of the preference table, the count value Utx of the sales history table, and the count value Ktx of the search history table as shown in FIGS. 14 (A) to 14 (C), and the weight coefficients 1 to 3 of the category (Cw1, Cw2, Cw3) as shown in FIG. 14 (D), and the preference coefficient Kks for search, the sales history coefficient Kku for search and the search history coefficient Kkk for search, to thereby determine a value Sx corresponding to the category code x as a resultant value.

Sx=[(Stx×Cw1)×Kks]+[(Utx×Cw2)×Kku]+[(Ktx×Cw3) ×Kkk](Equation 1)

In the example of FIG. 14, in the case of a column shown by (1) in FIG. 14 (E), 1×3+2×1+2×2=9 is obtained from the columns of the corresponding FIGS. 14(A) to 14(D), and in the case of a column shown by (2), 1×1+2×2+2×3=11 is obtained in the similar manner. Moreover, in the case where the total value of the count value corresponding to all the category codes for each customer ID is “1” or larger, “1” is set as a result flag, as shown in FIG. 14(E). The prepared search table is then stored in the DB 39. If the value of the trigger is changed, the value of the result flag also changes.

As described above, by using the preference coefficient Kks, the sales history coefficient Kku and the search history coefficient Kkk, which are coefficients for search, it becomes possible to narrow down each table itself. That is to say, it becomes possible to combine the preference table, the sales history table and the search history table.

As described above, according to the product information distribution system of the present invention, (i) weighting of individual preference table, sales history table and search history table becomes possible, (ii) weighting of the whole search table is also possible, and (iii) combination of the preference table, the sales history table and the search history table becomes possible. Therefore, it is possible to search more accurately by these three constructions.

(5) A Method of Preparing the Distribution Data

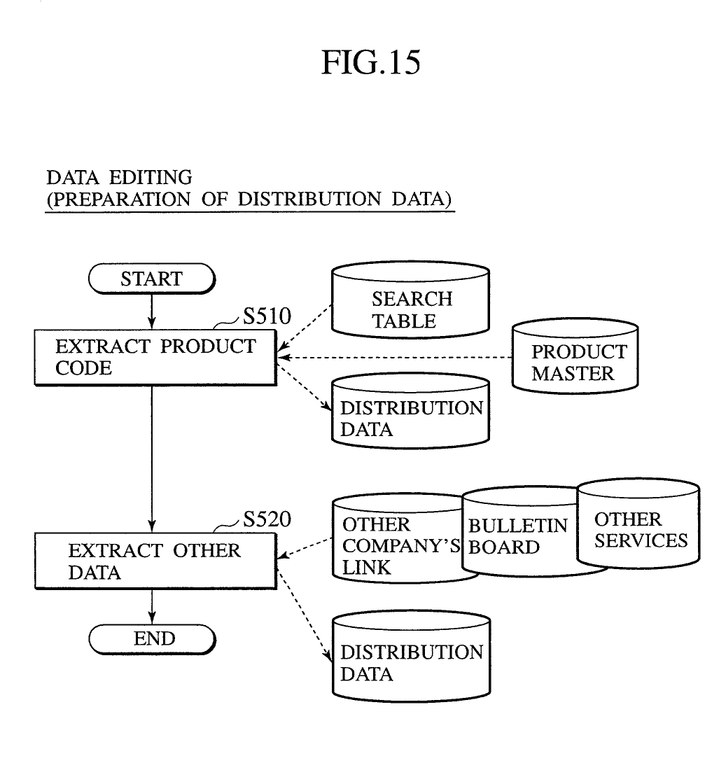

In step S90, a subroutine (FIG. 15) for preparing the distribution data is called up, referring to the search table.

As shown in FIG. 15, in step S510, the search table and the product master stored in the DB 39 are read out to the RAM. When the count value corresponding to the category code for each customer ID is 1 or larger, it is the category code representing the preference of the customer. Therefore, a product code corresponding to this category code is inversely subtracted and extracted from the product master, to thereby prepare the distribution data comprising the preference product code for each customer ID.

In step S520, other company's links, bulletin boards and other services corresponding to the category code representing the preference of the customer, in the case where the count value corresponding to the category code for each customer ID is 1 or larger, are read out and extracted, and added to the distribution data for each customer ID extracted in step S510.

Next, in step S100, the distribution data for each customer ID prepared on the RAM in step S90 is transferred to the contents DB 55 via the bus and stored therein.

(6) Judgment Processing Regarding Approval or Denial of the Distribution Service

In step S110, the search table stored in the DB 39 is read out to the RAM, and it is examined whether the result flags corresponding to all the customer IDs are “0” or not to thereby judge the existence of the distribution data. In the case where all the result flags are “0”, there is no distribution data. Therefore, this main routine is terminated. On the other hand, in the case where at least one of all the result flags is “1” or larger, there is distribution data, and the process proceeds to step S120.

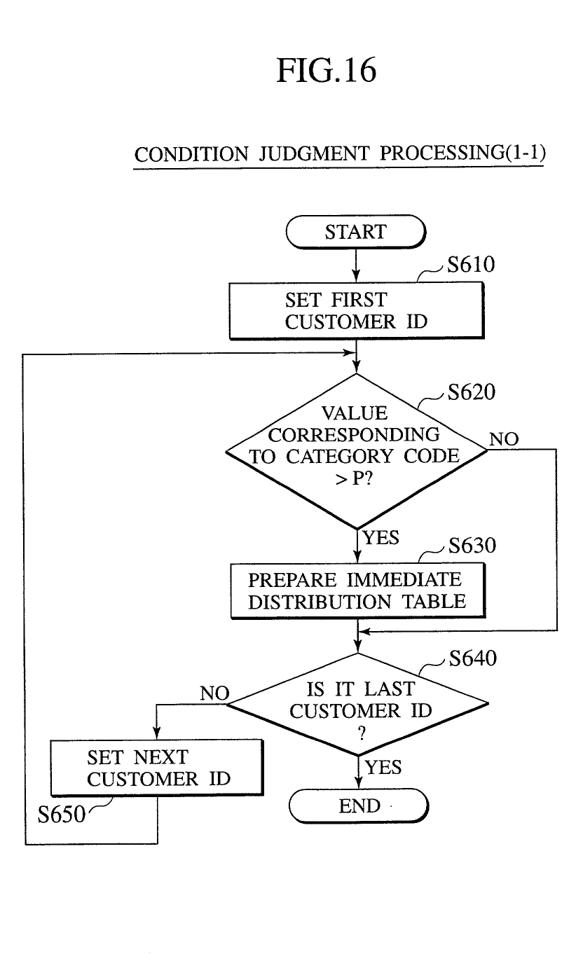

Next, in step S120, a subroutine (FIG. 16) is called up in order to perform the following condition judgment processing (1-1). As shown in FIG. 16, in step S610, the distribution data stored in the contents DB 55 is read, and from the first customer ID to the last customer ID are sequentially taken out from the distribution data and set in the RAM.

In step S620, the search table stored in the DB 39 is read out to the RAM, and it is judged whether or not any one of the count values corresponding to the category codes determined using the above equation (1) has reached a reference value P for judging that the preference and taste is high. Here, in the case where any one of the count values corresponding to the category codes has not reached the reference value P, the process proceeds to step S640.

On the other hand, in the case where any one of the count values corresponding to the category codes has reached the reference value P, the process proceeds to step S630, and the customer ID is stored in the immediate distribution data for immediately distributing the product information to the customer having high preference and taste.

In step S640, it is judged whether the process reached the last customer ID or not. If having not reached the last customer ID, the process proceeds to step S650, to set the next customer ID and proceeds to step S620. On the other hand, if having reached the last customer ID, the processing is terminated.

As a result, the first product is determined based on the count value Stx of the category code of the received customer and the weight coefficient Cw1×Kks corresponding to the customer's category code, the second product is determined based on the count value Utx of the category code of the product code and the weight coefficient Cw2×Kku corresponding to the customer's category code, and the third product is determined based on the count value Ktx of the category code of the URL address and the weight coefficient Cw3×Kkk corresponding to the customer's category code. Then, the product code most suitable for the customer's preference can be extracted based on the category code x in the case where the total value Sx of the above first to third products is larger than the predetermined reference value.

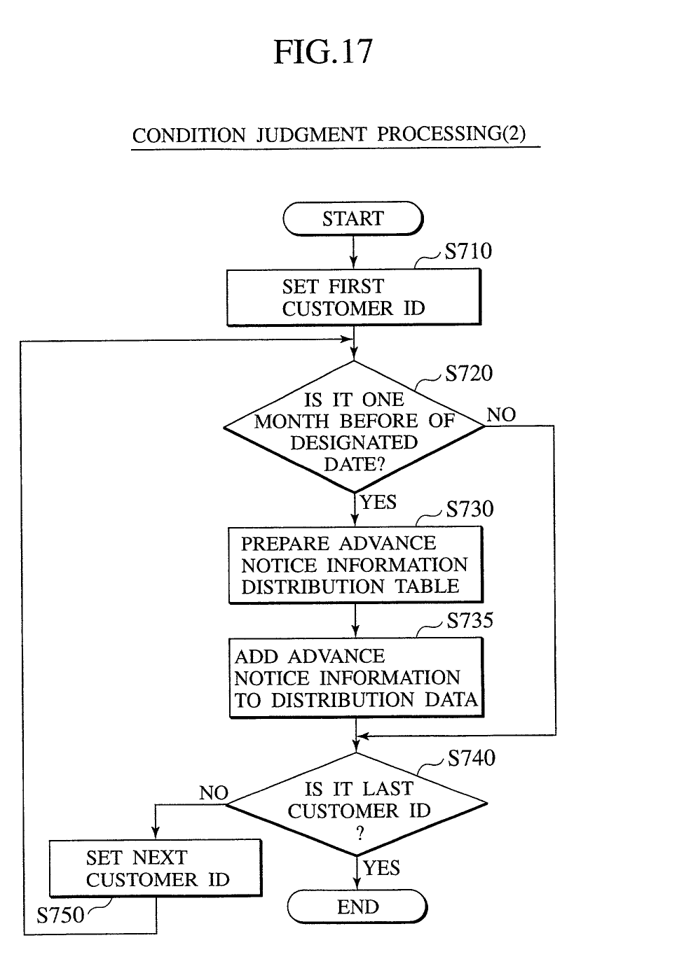

Next, in step S130, a subroutine is called up in order to perform the following condition judgment processing (2). As shown in FIG. 17, in step 710, the distribution data stored in the contents DB 55 is read, and from the first customer ID to the last customer ID are sequentially taken out from the distribution data and set in the RAM.

In step S720, the registered attribute of the customer master corresponding to the customer ID stored in the DB 39 is read out to the RAM, and it is judged whether or not the current date read from the timer corresponds to, for example, one month before of the designated date shown by the registered attribute. Here, in the case where the current date is not, for example, one month before of the designated date, the process proceeds to step S740.

On the other hand, in the case where the current date is, for example, one month before of the designated date, the process proceeds to step S730, and the customer ID is stored in the advance notice information distribution table for distributing the advance notice information showing that it is one month before of the designated date.

In step S735, the advance notice information showing that it is, for example, one month before of the designated date is prepared and added to the distribution data of the customer ID stored in the contents DB 55.

In step S740, it is judged whether the process reached the last customer ID or not. If having not reached the last customer ID, the process proceeds to step S750, to set the next customer ID and proceeds to step S720. On the other hand, if having reached the last customer ID, the processing is terminated.

Moreover, the above-described designated date includes, for example, the date for vehicle inspection, regular inspection or the like, the birthday, the date of consumption time limit of a product purchased in the shopping mall, the date when a product purchased in the shopping mall is to be consumed by a certain amount, or the like. The above-described advance notice information includes, for example, “It is one month before of the date for vehicle inspection or regular inspection”, “It is one month before the birthday”, “It is one month before of the date of consumption time limit of the product purchased in the shopping mall”, or “It is one month before of the date when the product purchased in the shopping mall is to be consumed by a certain amount”.

(7) A Method For Editing the Distribution Data

The distribution data prepared in step S90 comprising preference product codes for each customer ID, and the advance notice information is added to the distribution data in step S735.

Therefore, in step S140, the DB server 21 reads out the distribution data stored in the contents DB 55 to the RAM, and reads out the product information comprising product information and explanation (text) corresponding to the product code in the distribution data from the DB 39 for each customer ID, and edits it as the immediate distribution data, and further stores the data in the contents DB 55. Moreover, it is assumed that the product information is stored in the DB 39 in advance.

As a result, in the contents DB 55, there are stored, for each customer ID, product information comprising product information and explanation corresponding to the customer's preference and taste, information of other company's links, bulletin boards and other services, and the immediate distribution data consisting of the advance notice information for notifying beforehand the peculiar period for the customer.

(8) A Method For Distributing the Immediate Distribution Data

At first, in step S150, the DB server 21 reads out the immediate distribution table stored in the contents DB 55 to the RAM, and further reads out the immediate distribution data stored in the contents DB 55 for each customer ID stored in the immediate distribution table, to thereby transmit the data to the agent server 19 via the Internet 13.

As a result, the agent server 19 having received the immediate distribution data for each customer ID stores this immediate distribution data in the database, and can print out the immediate distribution data by the printer 20 as an information document. This information document can be put into an envelope to thereby form a direct mail, and can be mailed to each customer. This immediate distribution data can be also transmitted to the mobile terminal 17 carried by a sales person, for example, via the Internet.

The customer having received the direct mail can read the product information and explanation corresponding to the customer's preference and taste. Moreover, the customer can confirm the peculiar date for the customer, for example, the date for vehicle inspection, regular inspection, the date of consumption time limit of the product purchased by the customer, or the like.

Moreover, the sales person having received the immediate distribution data from the agent server 19 can give information and explanation of products corresponding to each customer's preference and taste, while visually checking the received immediate distribution data, and can also notify the peculiar date for that customer, for example, the date for vehicle inspection, regular inspection, the presentation of a gift before birthday, the date of consumption time limit of the product purchased by the customer, or the like. As a result, the customer service can be improved.

Next, in steps S160 and S170, the DB server 21 forms a preparation instruction (1) for instructing the Web server 23 to prepare a distributable E-mail from the immediate distribution data and outputs the instruction to the Web server 23 via a bus. The Web server 23 having received the preparation instruction (1) from the DB server 21 reads out the immediate distribution table stored in the contents DB 55 to the RAM, and further reads out the immediate distribution data stored in the contents DB 55 for each customer ID stored in the immediate distribution table, to thereby prepare the E-mail for the customer to receive, and stores the mail in the contents DB 55.

Here, for example, the communication terminal 15 such as a personal computer provided in the customer's residence is powered on, to activate the WWW browser for receiving the E-mail from the provider (information distribution company). When an IP address in the Web server 23 of a specific provider (information distribution company) is specified to start an access to the Internet 13, the telephone line is connected to the telephone number of the provider (information distribution company). Then, the customer ID is verified between the customer's communication terminal 15 and the communication control section 47 of the Web server 23. Furthermore, the E-mail stored in the contents DB 55 via the communication control section 47 of the Web server 23 can be downloaded to the communication terminal 15 via the Internet 13.

The customer having received the E-mail, using the communication terminal 15 can read the product information and explanation corresponding to the customer's preference and taste. Moreover, the customer can confirm the peculiar date for the customer, for example, the date for vehicle inspection, regular inspection, the date of consumption time limit of the product purchased by the customer, or the like.

According to the product information distribution system in this embodiment, based on the count of the category code of the customer received from the agent server and the weight coefficient corresponding to this customer's category code, a product code most suitable for the customer's preference is extracted, distribution information corresponding to the customer is prepared from the product contents corresponding to the extracted product code, and the prepared distribution information is distributed the agent server. Therefore, product contents most suitable for the customer's preference can be provided via the agent server.

Moreover, the URL address provided from the search service side to the customer's communication terminal is extracted. Based on the count of the category code corresponding to this extracted URL address and the weight coefficient corresponding to this customer's category code, a product code most suitable for the customer's preference is extracted, distribution information corresponding to the customer is prepared from the product contents corresponding to the extracted product code, and the prepared distribution information is stored as the E-mail to the customer. Therefore, this E-mail is taken in by the customer's communication terminal, to thereby provide the product contents most suitable for the customer's preference.

Furthermore, a product code of the product which has been ordered to the virtual mall by the customer's communication terminal is extracted. Based on the count of the category code corresponding to this extracted product code and the weight coefficient corresponding to this customer's category code, a product code most suitable for the customer's preference is extracted, distribution information corresponding to the customer is prepared from the product contents corresponding to the extracted product code, and the prepared distribution information is stored as the E-mail to the customer. Therefore, this E-mail is taken in by the customer's communication terminal, to thereby provide the product contents most suitable for the customer's preference.

Moreover, by preparing the advance notice information prior to the designated date designated by the customer by a predetermined period, the distribution information including the advance notice information can be distributed to the agent server, and via the agent server, the product contents most suitable for the customer's preference and the advance notice information can be provided.

Moreover, by preparing the advance notice information prior to the designated date designated by the customer by a predetermined period, the distribution information including the advance notice information can be stored as an E-mail to the customer. This E-mail is taken in by the customer's communication terminal, to thereby provide the product contents most suitable for the customer's preference and the advance notice information.

<Second Embodiment>

A second embodiment of the present invention uses the product information distribution system 11 shown in FIG. 1 applied in the first embodiment. The basic operation of the product information distribution system 11 in the second embodiment operates according to the flowchart shown in FIG. 4.

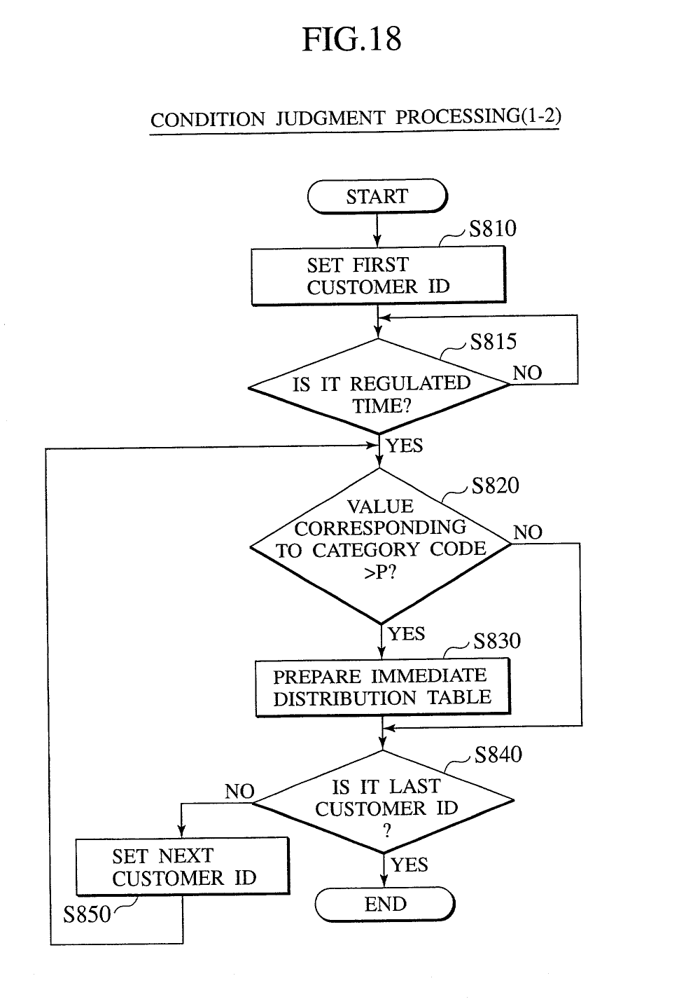

The feature of this embodiment is that the condition judgment processing (1-2) is executed by using a flowchart of a subroutine shown in FIG. 18, instead of FIG. 16 used in the first embodiment.

Next, in step S120, the subroutine (FIG. 18) is called up in order to perform the following condition judgment processing (1-2).

Referring to FIG. 18, in step S810, the distribution data stored in the contents DB 55 is read out, and from the first customer ID to the last customer ID are sequentially taken out from the distribution data and set in the RAM.

Here, in step S815, the current time is read in from the timer, and it is judged whether or not it coincides with “6:00”, “12:00 ”, “17:00” or “20:00”, for example, as the designated time for the morning, daytime, evening or night. If the current time does not coincide with these designated time, the process returns to step S815, to repeat the processing. On the other hand, if it becomes the designated time, the process proceeds to step S820.

In step S820, the search table stored in the DB 39 is read out to the RAM, and it is judged whether or not any one of the count values corresponding to the category codes using the equation (1) above described to determine has reached a reference value P indicating that the preference and taste is high. Here, in the case where any one of the count values corresponding to the category codes has not reached the reference value P, the process proceeds to step S840.

On the other hand, in the case where any one of the count values corresponding to the category codes has reached the reference value P, the process proceeds to step S830, and the customer ID is stored in the immediate distribution data for immediately distributing the product information to the customer having high preference and taste.

In step S840, it is judged whether the process reached the last customer ID or not. If having not reached the last customer ID, the process proceeds to step S850, to set the next customer ID and proceeds to step S820. On the other hand, if the process has reached the last customer ID, the processing is completed.

As a result, for example, in the case where it becomes the designated time of the morning, daytime, evening or night during one day, and the count value corresponding to the category table in the search table has reached the reference value P, the product contents having the product code corresponding to the category code are prepared as the distribution information. Thereby, the distribution information including the product contents most suitable for the keyword at the time of utilizing the search service is stored as the E-mail to the customer. Hence, this E-mail is taken in by the customer's communication terminal, to thereby provide the product contents most suitable for the customer's preference.

<Third Embodiment>

A third embodiment of the present invention uses the product information distribution system 11 shown in FIG. 1 applied in the first embodiment. The basic operation of the product information distribution system 11 in the third embodiment operates according to the flowchart shown in FIG. 4.

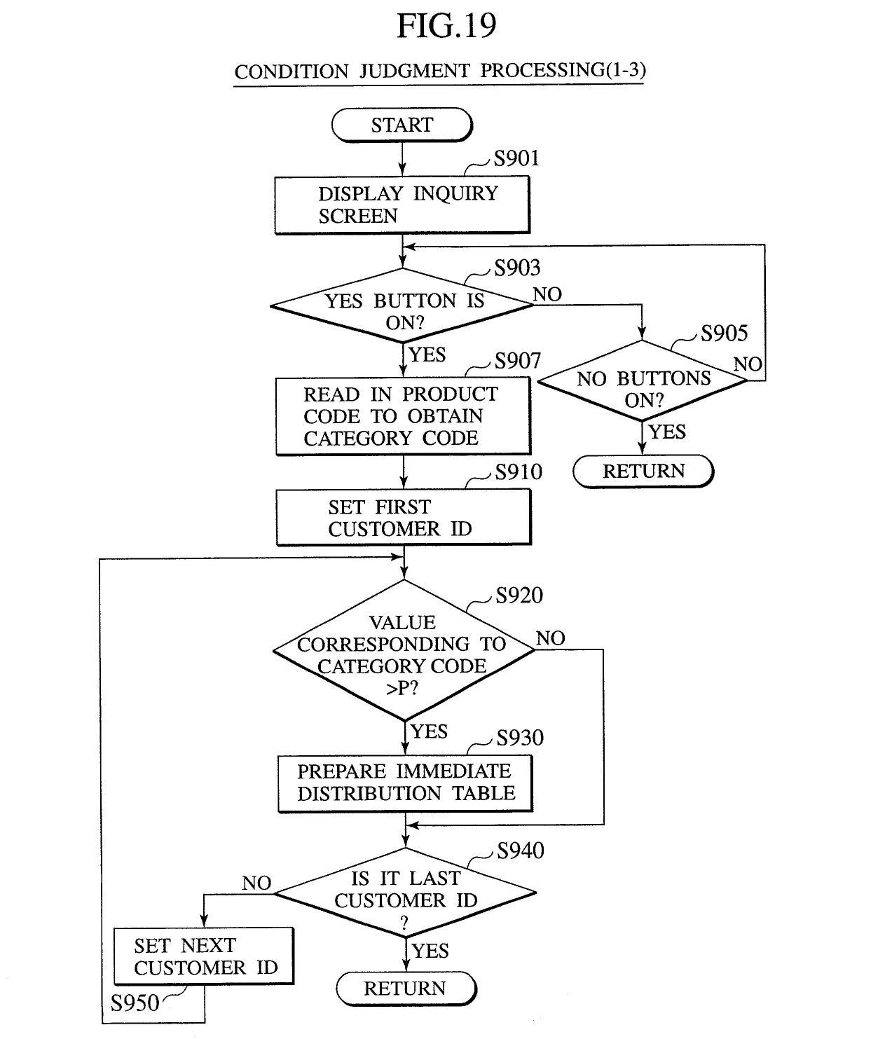

The feature of this embodiment is that the condition judgment processing (1-3) is executed by using a flowchart of a subroutine shown in FIG. 19, instead of FIG. 16 used in the first embodiment.

Next, in step S120, the subroutine (FIG. 19) is called up in order to perform the following condition judgment processing (1-3).

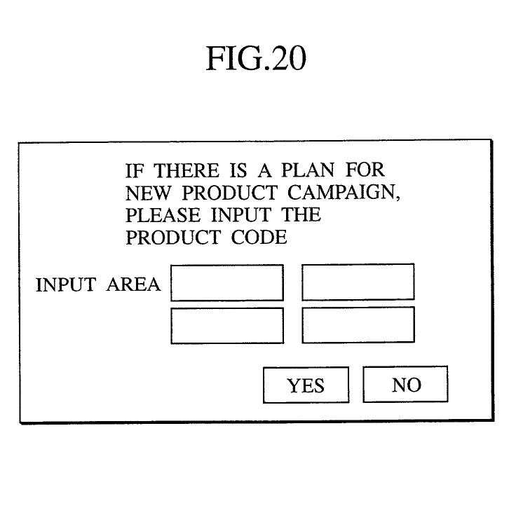

Referring to FIG. 19, in step S901, there are formed, for example, screen information for inquiring “if there is a plan of a new product campaign, please input that product code”, screen information indicating the input area for inputting the product code, and “YES” button information and “NO” button information for responding the existence of this “plan of the new product campaign”, and displayed on the display 35, as shown in FIG. 20.

Here, it is assumed that an operator having confirmed the screen information displayed on the display 35 inputs at least one specific product code corresponding to the input area from the keyboard 33, and pushes the “YES” button on the screen, using a pointing device such as a mouse (not shown).

In step S903, it is judged, for example, whether the “YES” button has been operated or not from the mouse (not shown). In the case where the “YES” button has not been operated, the process proceeds to step S905, and in the case where the “NO” button has not been operated, the process returns to step S903 to repeat the above processing. On the other hand, in the case where the “NO” button has been operated, this subroutine is finished to return to the main routine.

In the case where the “YES” button is operated with respect to the display screen, the process proceeds to step S907 to read in the product code input on the screen, and respective category codes corresponding to this product code are read out from the product master stored in the DB 39, and obtained.

In step S910, the distribution data stored in the contents DB 55 is read out, and the first customer ID to the last customer ID are sequentially taken out from the distribution data and set in the RAM.

In step S920, the search table stored in the DB 39 is read out to the RAM, and with respect to only the category code obtained in step S907, it is judged whether or not any one of the count values corresponding to the category codes using the equation (1) above described to determine has reached a reference value P indicating that the preference and taste is high. Here, in the case where any one of the count values corresponding to the category codes has not reached the reference value P, the process proceeds to step S940.

On the other hand, in the case where any one of the count values corresponding to the category codes has reached the reference value P, the process proceeds to step S930, and the customer ID is stored in the immediate distribution data for immediately distributing the product information to the customer having high preference and taste.

In step S940, it is judged whether the process reached the last customer ID or not. If having not reached the last customer ID, the process proceeds to step S950, to set the next customer ID and proceeds to step S920. On the other hand, if the process has reached the last customer ID, the processing is completed.

As a result, if there is a plan for the new product campaign, and when the count value corresponding to the category code corresponding to this product code has reached the reference value P, a customer having high preference and taste with respect to that product, that is, a customer who can be assumed to have high preference and taste with respect to the new product can be extracted, and the product contents having this product code can be prepared as the distribution information and distributed.

<Fourth Embodiment>

A fourth embodiment of the present invention uses the product information distribution system 11 shown in FIG. 1 applied in the first embodiment.

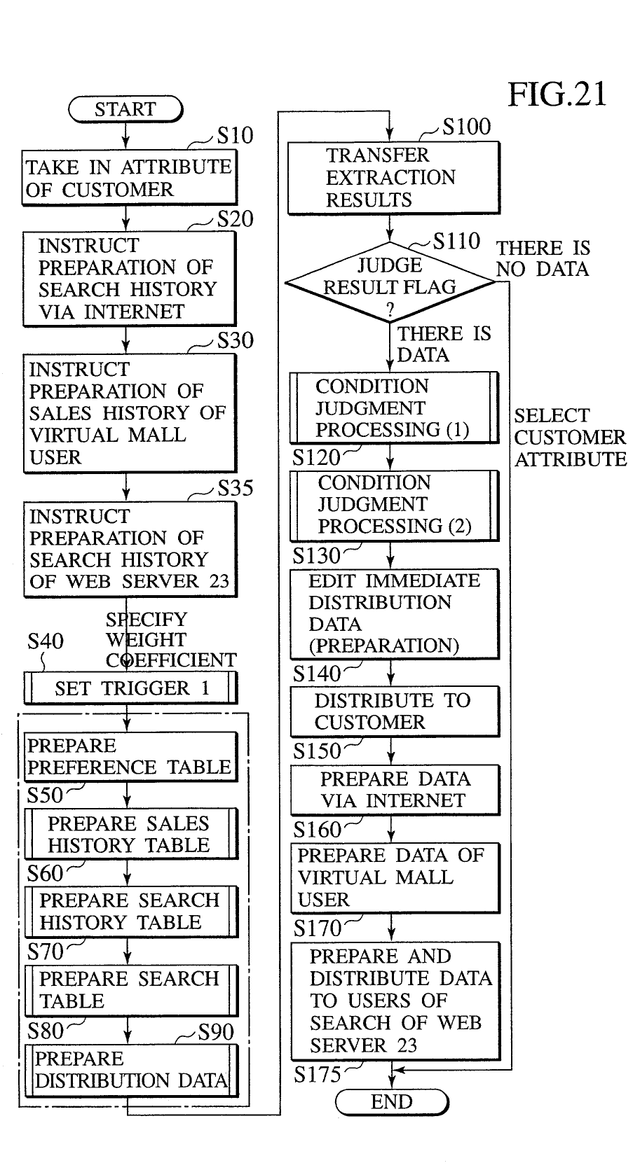

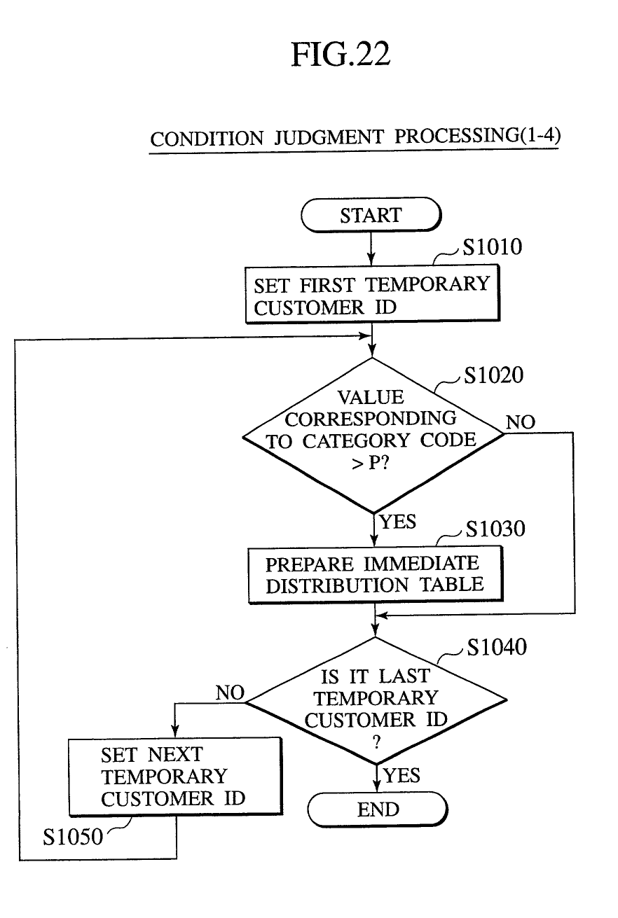

The feature of the product information distribution system in this embodiment is that the product information distribution system 11 operates according to the flowchart shown in FIG. 21 and the condition judgment processing (1-4) is executed by using a flowchart of a subroutine shown in FIG. 22, instead of FIG. 16 used in the first embodiment. The description of the same step shown in FIG. 4 is omitted.

In FIG. 21, step S35 is added with respect to the flowchart shown in FIG. 4, and step S175 is added instead of step S170. Moreover, other steps are the same as respective steps in FIG. 4, and the description thereof is omitted.

In step S35, the Internet 13 is connected to the Web server 23, and a communication terminal (not shown) of a non-member generates a search history preparation instruction for storing in the DB server 21 the search history indicating the result of searching the contents DB 55 via the Web server 23, and outputs this to the Web server 23 via a bus. The Web server 23 having received the search history preparation instruction from the DB server 21 instructs the communication control section 47 to obtain the search history (cookie) including a temporary customer ID, date, and the URL address of the Web site from the communication information now searching the contents DB 55, and stores this cookie in the DB 39 managed by the DB server 21, from the Web server 23 via the bus.

In the case where the contents DB 55 is searched from a communication terminal (not shown) of a non-member via the Internet 13, for example, a message, “We will distribute product information corresponding to your preference and taste. Therefore, please input your E-mail address.” is transmitted from the Web server 23, as a message stored in the contents DB 55 beforehand, and the E-mail address responded by the non-member is extracted. This extracted E-mail address of the non-member is transferred to the control section 41 of the DB server 21 from the Web server 23 via the bus.

The control section 41 of the DB server 21 having received the E-mail address of the non-member from the Web server 23 allots a temporary customer ID for the non-member. Furthermore, this E-mail address of the non-member is added to the search history (cookie) including the URL address of the Web site, to be stored in the DB 39.

Moreover, in the contents DB 55 of the Web server 23, there is stored a questionnaire form for registering the temporary customer's attribute data in the same format as that of the customer master shown in FIG. 2A, and by moving from the menu page to the questionnaire page of the Web server 23, this questionnaire form can be downloaded to the communication terminal 15 of the temporary customer. When the temporary customer enters the own attribute data in the questionnaire form on the communication terminal 15, and then pushes the transmission button added in this page, the response to the questionnaire can be transmitted to the Web server 23 and uploaded. Furthermore, this response is also transferred to the DB server 21 from the Web server 23 via the bus. The DB server 21 having received the temporary customer's attribute data from the Web server 23, adds a characteristic temporary customer ID to the temporary customer's attribute data to generate a temporary customer master, and stores this in the DB 39.

Next, in step S70, a subroutine (FIG. 11) is called up in order to prepare a search history table from the search history.

Referring to FIG. 11, in step S310, the control section 41 of the DB server 21 reads in the search date and the URL address regarding each temporary customer ID to the RAM from the search history stored in the DB 39, as shown in FIG. 12 (A).

In step S320, the control section 41 of the DB server 21 obtains a category code corresponding to the URL address read in to the RAM, referring to the category master (FIG. 12 (B)). Furthermore, the category codes are added up for each temporary customer ID. That is to say, as in the summary report shown in FIG. 12 (C), the count of the same category code is calculated for each temporary customer ID.

In step S330, the search history table is prepared. That is to say, as shown in FIG. 12 (D), the temporary customer ID is allotted in the longitudinal direction of the search history table. Next, respective category codes are read out from the product master stored in the DB 39, and allotted as the category code in the lateral direction of the search table, as shown in FIG. 12 (D). Furthermore, the count of the category code calculated in step S320 is respectively set for each temporary customer ID.

Next, in step S120, a subroutine (FIG. 22) is called up for performing the condition judgment processing (1-4).

Referring to FIG. 22, in step S1010, the distribution data stored in the contents DB 55 is read out, and from the first customer ID to the last customer ID are sequentially taken out from the distribution data and set in the RAM.

In step S1020, the search table stored in the DB 39 is read out to the RAM, and it is judged whether or not any one of the count values corresponding to the category codes determined by the equation (1) above described has reached a reference value P indicating that the preference and taste is high. Here, in the case where any one of the count values corresponding to the category codes has not reached the reference value P, the process proceeds to step S1040.

On the other hand, in the case where any one of the count values corresponding to the category codes has reached the reference value P, the process proceeds to step S1030, and the temporary customer ID is stored in the immediate distribution data for immediately distributing the product information to the temporary customer having high preference and taste.

In step S1040, it is judged whether the process reached the last temporary customer ID or not. If having not reached the last temporary customer ID, the process proceeds to step S1050, to set the next temporary customer ID and proceeds to step S1020. On the other hand, if having reached the last temporary customer ID, the processing is terminated.

Next, in step S175, the DB server 21 generates a preparation instruction (1) for instructing the Web server 23 to prepare a distributable E-mail from the immediate distribution data and output this to the Web server 23 via a bus. The Web server 23 having received the preparation instruction (1) from the DB server 21 reads out the immediate distribution table stored in the contents DB 55 to the RAM. The Web server 23 further reads out the immediate distribution data stored in the content DB 55 for each temporary customer ID stored in the immediate distribution table, to thereby prepare an E-mail for the temporary customer to receive. Furthermore, the Web server 23 reads out the E-mail prepared for each temporary customer ID from the contents DB 55, and distributes this to the E-mail address.

As a result, the temporary customer having received this E-mail can read the product information and explanation corresponding to the customer's preference and taste.

With the product information distribution system according to this embodiment, the URL address at the time when a communication terminal of a non-customer searched the contents DB 55 provided in the Web server 23 is extracted from the communication control section 47. Based on the count of the category code corresponding to this extracted URL address by the DB server 21 and the weight coefficient corresponding to the category code, the product code most suitable for the preference of the non-customer is extracted, and the distribution information corresponding to the non-customer is prepared from the product contents corresponding to the extracted product code, and the prepared distribution information is stored as an E-mail to the non-customer. Therefore, this E-mail is taken in by the non-customer's communication terminal, to thereby provide the product contents most suitable for the preference of the non-customer.

This application claims benefit of priority under 35USC§119 to Japanese Patent Applications No. 2000-001538, filed on Jan. 9, 2001, the entire contents of which are incorporated by reference herein.

What is claimed is:

1. A product information distribution system comprising a server for exchanging information via an information network with an agent server which collects customer information, wherein
the server comprising:
product information storing means for storing product guidance information together with a product code added thereto;
preference attribute storing means for storing the correspondence between the product code and a preference attribute code representing classification of preferences;
weight coefficient storing means for storing a weight coefficient corresponding to the preference attribute code;
reception means for receiving a preference attribute code of a customer from the agent server;
preference product extraction means for extracting a product code most suitable for the preference of the customer from the preference attribute storing means, based on the count of the received preference attribute code of the customer and the weight coefficient corresponding to the preference attribute code of the customer read from the weight coefficient storing means;
distribution information preparation means for preparing distribution information corresponding to the customer by reading out the product contents corresponding to the product code extracted from the product information storing means; and
distribution means for distributing the prepared distribution information to the agent server.

2. A product information distribution system comprising a server for connecting communication between a communication terminal of a customer and a virtual mall via an information network, wherein
the server comprising:
product information storing means for storing product guidance information together with a product code added thereto;
preference attribute storing means for storing the correspondence between the product code and a preference attribute code representing classification of preferences;
weight coefficient storing means for storing a weight coefficient corresponding to the preference attribute code;
product code extraction means for extracting a product code of a product ordered to the virtual mall by the communication terminal of the customer;
preference product extraction means for extracting a product code most suitable for the preference of the customer from the preference attribute storing means, based on the count of the preference attribute code corresponding to the extracted product code and the weight coefficient corresponding to the preference attribute code of the customer read from the weight coefficient storing means;
distribution information preparation means for preparing distribution information corresponding to the customer by reading out the product contents corresponding to the product code extracted from the product information storing means; and
information storing means for storing the prepared distribution information as an E-mail to the customer.

3. A product information distribution system comprising a server for connecting communication between a communication terminal of a customer and the search service side via an information network, wherein
the server comprising:
product information storing means for storing product guidance information together with a product code added thereto;
preference attribute storing means for storing the correspondence between the product code and a preference attribute code representing classification of preferences;
URL address storing means for storing a URL address corresponding to the preference attribute code;
weight coefficient storing means for storing a weight coefficient corresponding to the preference attribute code;
URL address extraction means for extracting the URL address provided to the communication terminal of the customer by the search service side;
preference product extraction means for extracting a product code most suitable for the preference of the customer from the preference attribute storing means, based on the count of the preference attribute code corresponding to the extracted URL address and the weight coefficient corresponding to the preference attribute code of the customer read from the weight coefficient storing means;
distribution information preparation means for preparing distribution information corresponding to the customer by reading out the product contents corresponding to the product code extracted from the product information storing means; and
information storing means for storing the prepared distribution information as an E-mail to the customer.

4. A server in a product information distribution system, the server connecting communication with an agent server which collects customer information via an information network, and comprising:
product information storing means for storing product guidance information together with a product code added thereto;
preference attribute storing means for storing the correspondence between the product code and a preference attribute code representing classification of preferences;
weight coefficient storing means for storing a weight coefficient corresponding to the preference attribute code;
reception means for receiving a preference attribute code of a customer from the agent server;
preference product extraction means for extracting a product code most suitable for the preference of the customer from the preference attribute storing means, based on the count of the received preference attribute code of the customer and the weight coefficient corresponding to the preference attribute code of the customer read from the weight coefficient storing means;
distribution information preparation means for preparing distribution information corresponding to the customer by reading out the product contents corresponding to the product code extracted from the product information storing means; and
distribution means for distributing the prepared distribution information to the agent server.

5. A server in a product information distribution system, the server connecting communication with an agent server which collects customer information, communication terminals of customers, virtual malls and the search service side via an information network, and comprising:
product information storing means for storing product guidance information together with a product code added thereto;
preference attribute storing means for storing the correspondence between the product code and a preference attribute code representing classification of preferences;
URL address storing means for storing a URL address corresponding to the preference attribute code;
weight coefficient storing means for storing a weight coefficient corresponding to the preference attribute code;
reception means for receiving a preference attribute code of a customer from the agent server;
product code extraction means for extracting a product code of a product ordered to the virtual mall by the communication terminal of the customer;
URL address extraction means for extracting the URL address provided to the communication terminal of the customer by the search service side;
preference product extraction means for extracting a product code most suitable for the preference of the customer from the preference attribute storing means, based on the count of the preference attribute code of the customer and the weight coefficient corresponding to the preference attribute code of the customer read from the weight coefficient storing means;
distribution information preparation means for preparing distribution information corresponding to the customer by reading out the product contents corresponding to the product code extracted from the product information storing means; and
distribution means for distributing the prepared distribution information to the agent server, wherein
the preference product extraction means
determines a first product based on the count of the preference attribute code of the customer received by the reception means and the weight coefficient corresponding to the preference attribute code of the customer read from the weight coefficient storing means;
determines a third product based on the count of the preference attribute code corresponding to the product code extracted by the product code extraction means and the weight coefficient corresponding to the preference attribute code of the customer read from the weight coefficient storing means;
determines a second product based on the count of the preference attribute code corresponding to the URL address extracted by the URL address extraction means and the weight coefficient corresponding to the preference attribute code of the customer read from the weight coefficient storing means; and
extracts a product code most suitable for the preference of the customer from the preference attribute storing means, based on a preference attribute code in the case where the sum total of the first product, the second product and the third product is larger than a predetermined reference value.

6. A product information distribution system according to any one of claim 1 to claim 3, wherein
the distribution information preparation means prepares advance notice information prior to a designated date designated by the customer by a predetermined period.

7. A product information distribution system according to claim 2, wherein
the distribution information preparation means prepares product contents having a product code corresponding to a preference attribute code of which the count corresponding to the product code extracted by the product code extraction means has reached a predetermined reference value as the distribution information when it becomes the designated time.

8. A product information distribution system according to any one of claim 1 to claim 3, wherein
the distribution information preparation means prepares product contents having the product code as the distribution information when the count value of the preference attribute code corresponding to a specified product code has reached a predetermined reference value.

9. A product information distribution system comprising a server for communicating with a communication terminal of a non-customer via an information network, wherein
the server comprising:
product information storing means for storing product guidance information together with a product code added thereto;
preference attribute storing means for storing the correspondence between the product code and a preference attribute code representing classification of preferences;
URL address storing means for storing a URL address corresponding to the preference attribute code;
weight coefficient storing means for storing a weight coefficient corresponding to the preference attribute code;
URL address extraction means for extracting the URL address at the time when a communication terminal of the non-customer searched the database provided in the server;
preference product extraction means for extracting a product code most suitable for the preference of the non-customer from the preference attribute storing means, based on the count of the preference attribute code corresponding to the extracted URL address and the weight coefficient corresponding to the preference attribute code of the customer read from the weight coefficient storing means;
distribution information preparation means for preparing distribution information corresponding to the non-customer by reading out the product contents corresponding to the product code extracted from the product information storing means; and
information storing means for storing the prepared distribution information as an E-mail to the non-customer.
